(19) United States
(12) Patent Application Publication
(10) Pub. No.: US 2003/0146616 A1
(43) Pub. Date: Aug. 7, 2003

(54) Adaptor for coverting bulk solids container for fluid transport /storage

(76) Inventors: Graham Francis Twomey, Geraldton (AU); William Mark Dyson, Geraldton (AU)

Correspondence Address: Steven L Permut, Reising Ethington Barnes Kisselle, Learman & McCulloch, P O Box 4390, Troy, MI, 48099-9998, US

(21) Appl. No.: 10/258,209

(22) PCT Filed: Jan. 19, 2001
(86) PCT No.: PCT/AU01/00053

(51) Int. Cl. B60P 3/22

(52) U.S. Cl. 280/830

(57) ABSTRACT

An adaptor (11) for converting a bulk solids container (13) for fluid storage/transportation comprising a rigid tank (23) secured to a base member (27) and moveable between a raised position in which the container (13) can hold bulk solids, and a lowered position in which the rigid tank (23) can contain fluid.

### FIELD OF THE INVENTION

The present invention relates to the transport and storage of bulk goods, and in particular an apparatus and method for maximising the potential usage of bulk goods transport vehicles and storage facilities.

### BACKGROUND ART

Goods transport vehicles for road and rail use are usually purpose built with a particular application in mind. Consequently there are many-types of vehicle body employed for road and rail transport usage. In the case of railway wagons/cars, these vehicle bodies include gondolas and hopper cars for the transport of bulk solid goods such as coal, ores, and grain, box cars for the transport of manually handled bulk goods and refrigerated goods, tankers for transport of fluids, and flat cars for transport of container traffic and other items. There are also many other types of specially designed railway wagons.

Railways are often used for the transport of bulk solid goods such as ores and grains, in trains made up of many identical hopper wagons. In the case of ore transport, the ore is often transported in this manner from the mine site or a central stock-pile from a number of mine sites, to a refinery or port for processing or shipping, respectively. The train then returns with empty hopper wagons, to be refilled and repeat the journey.

There is often a need for the transport of liquid goods such as fuel and the like to such a mine site. If these liquid goods are transported by rail, this can be accomplished by coupling the appropriate tanker wagons to the train, and transporting the liquid goods along with empty hopper wagons. Similarly, bulk solid goods such as ores are transported out from a mine to a port or processing plant by road in open bodied trucks which then return empty to the mine, and tanker trucks bring liquid goods such as fuels to the mine and return empty therefrom.

The applicant has proposed a system which will enable dual use of open bodied trucks, using a bladder which is deployed from a collapsed upward position stowed above the open body (allowing the open body to hold bulk solids for transport) to a downward lowered position in which it substantially occupies the open body (allowing the bladder to hold fluids for transport). This arrangement is the subject of the applicant's international patent application PCT/AU99/00457. However, difficulty has been encountered with the storage and transport of certain corrosive liquids, particularly due to damage caused by the corrosive liquids to the bladder and its component parts. While an alternative flexible bladder material might be obtained or developed, which is impervious to the corrosive liquids in question, the costs are considered to outweigh the benefit, and this has led the applicant to look for an alternative solution to the problem. The invention may have application in bulk liquid storage and transport containers, to allow transport and storage of more than one type of fluid, without the need for cleaning, and while avoiding cross contamination. The invention could also have application in bulk solids storage containers, for example in silos used on farms.

### DISCLOSURE OF THE INVENTION

The invention resides in a tank stowage and deployment apparatus for a body used for the stowing storage or transport of goods.

Throughout the specification, unless the context requires otherwise, the word “comprise” or variations such as “comprises” or “comprising”,will be understood to imply the inclusion of a stated integer or group of integers but not the exclusion of any other integer or group of integers.

In accordance with one aspect of the invention there is provided, in an open topped body used for the stowing, storage, or transport of goods, the body having a base bounded by side(s); a rigid tank supported from an upper region of said body, said rigid tank being supported on a base member, said base member being movable between an upward position in which said rigid tank is raised substantially above said body and said body can be used for stowage of goods, and a downward position in which said rigid tank is located substantially within said body and can be used for holding fluid.

In accordance with a second aspect of the invention there is provided an adaptor to allow an open topped body used for the stowing, storage, or transport of goods, to hold bulk fluid without cross contamination, the body having a base bounded by side(s), wherein said adaptor comprises a rigid tank supported from an upper region of said body, said rigid tank being supported on a base member, said base member being movable between an upward position in which said rigid tank is raised substantially above or in an upper region of said body and said body can be used for stowage of goods, and a downward position in which said rigid tank is located within said body and can be used for holding fluid.

In accordance with a third aspect of the invention there is provided, a freight vehicle comprising an open topped body used for the stowing, storage, or transport of goods, the body having a base bounded by side(s); wherein a rigid tank is supported from an upper region of said body, said rigid tank being supported on a base member, said base member being movable between an upward position in which said rigid tank is raised substantially above said body and said body can be used for stowage of goods, and a downward position in which said rigid tank is located substantially within said body and can be used for holding fluid.

It will be appreciated that the term “side(s)” encompasses a cylindrical body having a side wall of circular cross-section, or a square, rectangular, or other polygonal body having a plurality of walls.

Preferably sealing means are provided to seal said body when said base member is in said upward position to prevent loss of goods during transport.

Preferably said sealing means is attached to said adaptor.

In accordance with a preferred feature of any of the preceding aspects of the invention, said base member is supported from a frame assembly which attaches to said body, said frame assembly having an aperture located therein through which said rigid tank may pass, said sealing means being provided to seal between said base member and said frame assembly in said upward position to form a cover for said body.

Preferably said sealing means is attached to said base member.

Preferably said base member has dimensions which exceed the maximum dimensions of said aperture, said sealing means being provided between the upper surface of said base member and the lower surface of said frame assembly around said aperture.

Alternatively said sealing means is located proximal to said base member, to interfere with said frame assembly as said base member is moved toward said raised position.

Preferably said frame assembly is pivotally attached to said body to facilitate loading of said body with bulk solids when in said upward position.

### BRIEF DESCRIPTION OF THE DRAWINGS

A preferred embodiment of the invention will now be described in the following description, made with reference to the drawings in which:

FIG. 1 is a perspective view from above of a side tipping trailer incorporating an adaptor for carrying fluids, shown in the downward position, according to the embodiment;

FIG. 2 is perspective view from above of the side tipping trailer of FIG. 1 incorporating the adaptor for carrying fluids, shown in the upward position;

FIG. 3 is a front cross-section view of the side tipping trailer incorporating the adaptor for carrying fluids, shown in the upward position;

FIG. 4 is a front cross-section view of part of FIG. 3 showing sealing means detail;

FIG. 5 is a front cross-section view of the side tipping trailer incorporating the adaptor for carrying fluids, shown in the upward position and pivoted open for loading the side tipping trailer with bulk solids;

FIG. 6 is a front cross-section view of the side tipping trailer incorporating the adaptor for carrying fluids, shown in the downward position;

FIG. 7 is a side cross-section view of the side tipping trailer incorporating the adaptor for carrying fluids, shown in the downward position;

FIG. 8 is a side cross-section view of part of FIG. 7 showing detail of part of a locking mechanism locking the adaptor in the downward position;

FIG. 9 is a side cross-section view of the side tipping trailer incorporating the adaptor for carrying fluids, shown in the upward position;

FIG. 10 is a side cross-section view of part of FIG. 9 showing detail of part of the locking mechanism locking the adaptor in the upward position;

FIG. 11 is a plan cross-section view showing detail of part of the locking mechanism in an unlocked condition, for locking the adaptor; and

FIG. 12 is a plan cross-section view showing detail of part of the locking mechanism in a locked condition, for locking the adaptor.

### BEST MODE(S) FOR CARRYING OUT THE INVENTION

The embodiment is an adaptor 11 to convert an open-top bulk-solids side tipping ore carrying trailer 13 for fluid transport. The trailer 13 is one of a type ordinarily coupled to a prime mover (not shown), or to other trailers coupled to a prime mover to form a road train.

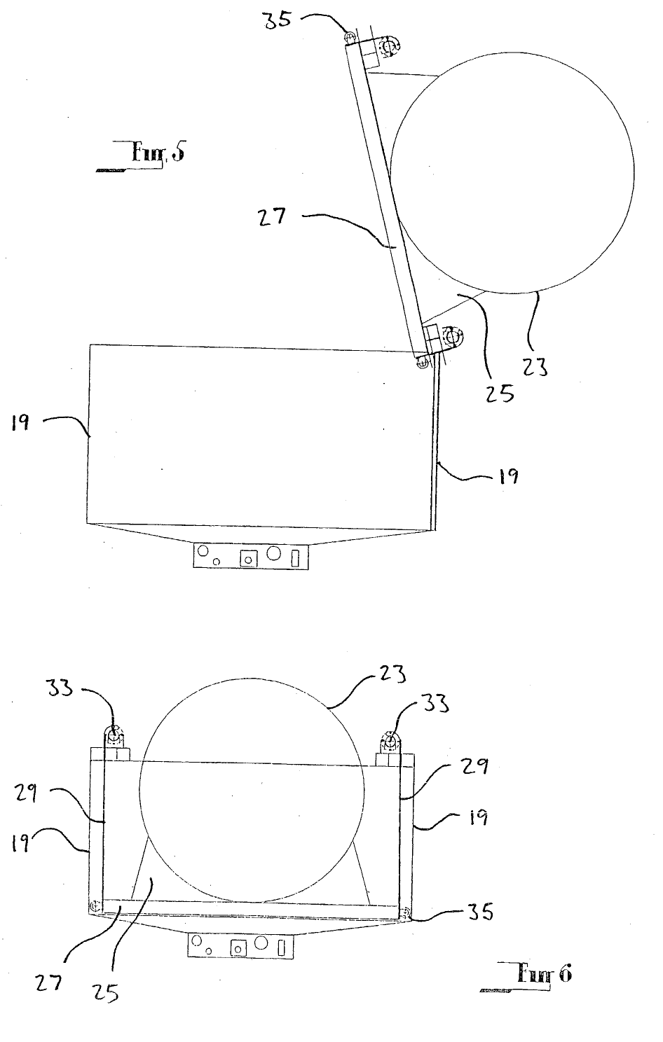

The adaptor 11 includes a frame assembly 15 configured to fit to and be secured on the upper rim 17 of the sides 19 and ends 21 of the trailer. The frame assembly 15 incorporates a hinging arrangement, so that the adapter 11 can be hingedly pivoted upwards as shown in FIG. 5, to allow the trailer 13 to be filled with bulk solids for transport. The adaptor 11 also includes a rigid stainless steel tank 23 attached to supports 25 in turn attached to a base member 27. The base member 27 is secured to the frame assembly using twelve lengths of 50 mm load strapping 29, each length of load strapping 29 being secured to a pulley and bearing assembly 31. The load strapping 29 is a reinforced polyester webbing (Type 108) having a failure load of approximately 24 kN.

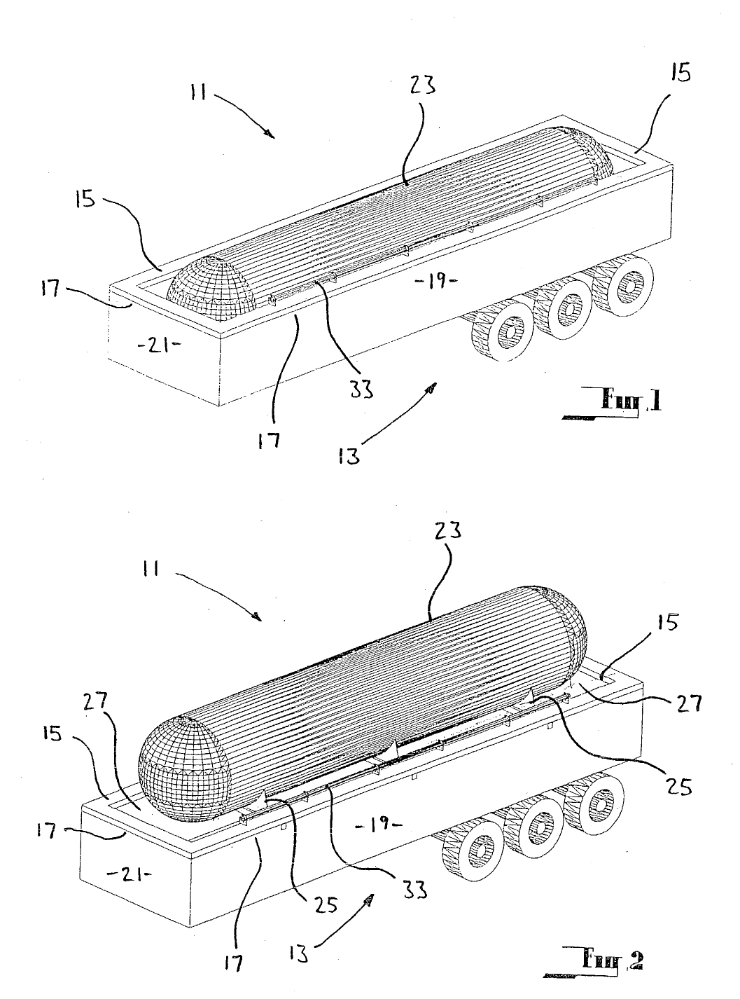

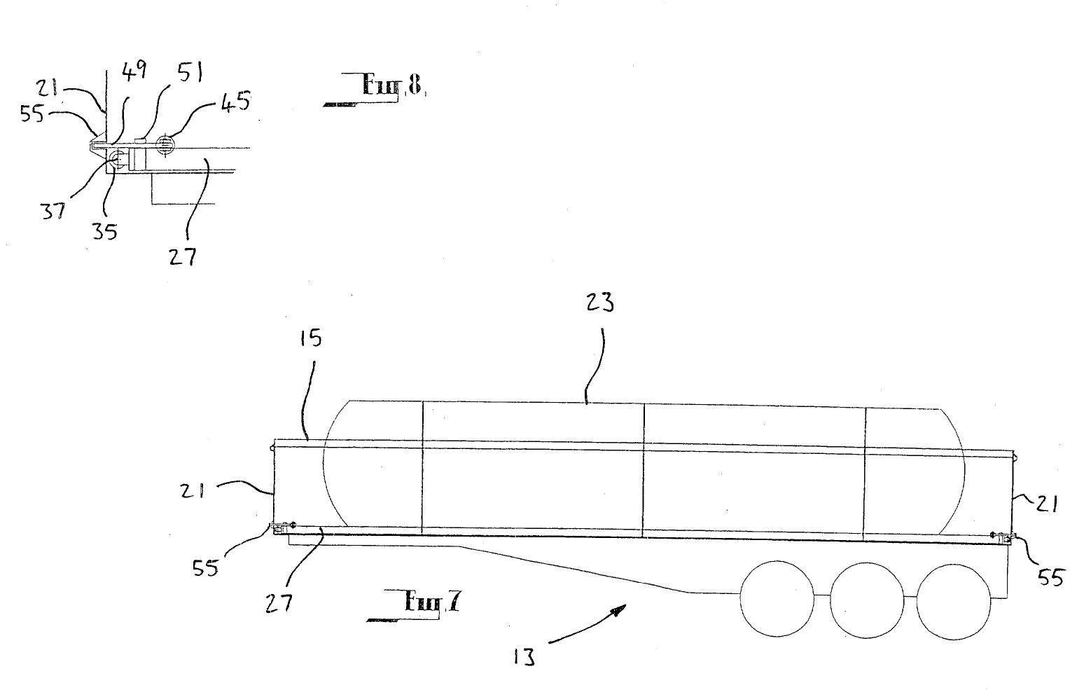

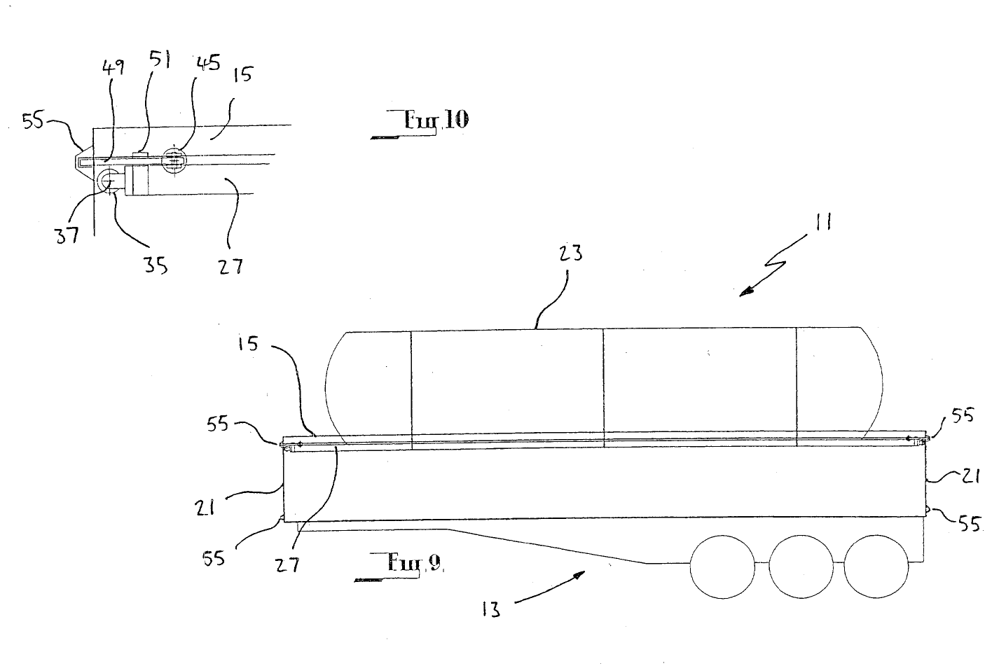

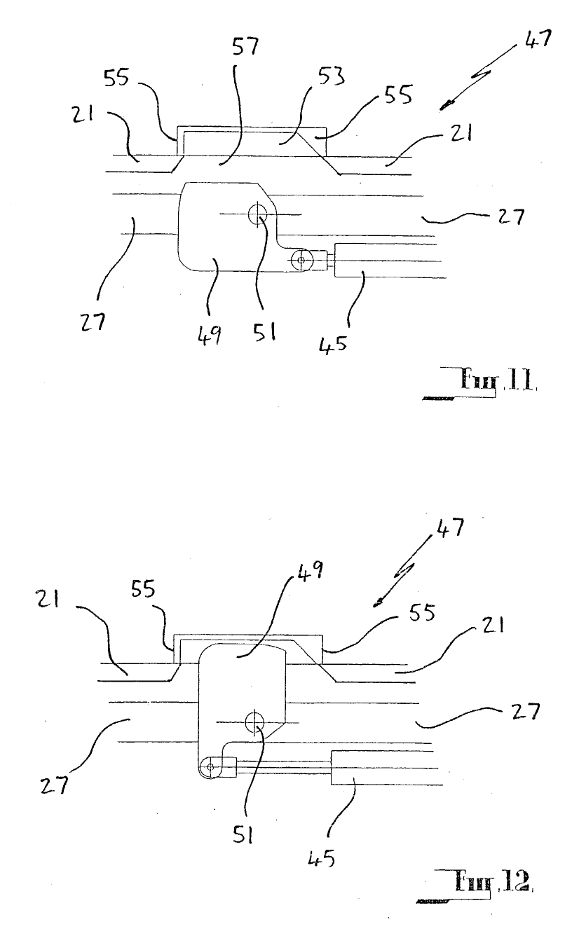

There are six of the pulley and bearing assemblies 31 on each side of the frame assembly 15, secured for rotation with a longitudinal rotary shaft 33. The longitudinal rotary shafts 33, mounted one on each side of the frame assembly, are operated in synchronised manner, being turned by a hydraulic rotary motor (not shown). Together, the hydraulic motor, rotary shafts 33, pulleys 31, and load strapping 29 form hoist means, operable to move the base member 27 (and attached tank 23) between an upward position (shown in FIGS. 2, 3, 5, and 9) and a downward position (shown in FIGS. 1, 6, and 7).

Located in spaced relation around the periphery of the base member 27 are bearing mounted rollers 35 secured in a clevis member 37. The rollers 35 serve to guide upward or downward movement of the adapter 11 within the trailer 13.

In the upward position, the tank 23 is disposed above the load carrying space of the body of the trailer 13, allowing the load carrying space to be used for carriage of a bulk solids load. A box section supporting rail 39 is located around the internal periphery of the frame assembly 15 and carries a rubber seal 41, which sealingly contacts against the upper surface of a peripheral ledge 43 supported above the base member 27. The area between the peripheral ledge 43 and the base member 27 is occluded, so that the bulk solids load carrying space of the trailer 13 is sealed off by the seal 41, which prevents the load being disturbed and blown out of the trailer 13 when the trailer is driven or in windy conditions.

In the downward position, the tank 23 is located within the load carrying space of the trailer 13, and can be used to carry liquids. With the tank 23 is located within the load carrying space of the trailer 13, and the weight of liquid in the tank 23, the centre of gravity of the assembly of adaptor 11 and trailer 13 is lower than would be the case if the tank 23 was not lowered into the trailer 13. While the adapter when empty and in the upward position does lift the centre of gravity of the trailer, the change in position of centre of gravity is not significant enough to be a safety issue, as long as it is born in mind by the driver of the prime mover, as is the case with transport of any tall load.

To lock the adapter 11 in the upward or downward position, locking means is provided by hydraulic ram 45 actuated latch 47, comprising a bar 49 mounted rotatably about a pin 51, the bar being received in a slot 53 formed in a body 55 accessible through a recess 57 located in the wall of the ends 21 of the trailer 13. There are four such hydraulic ram 45 actuated latches 47, located one proximal to each corner of the base member 27. Thus there are eight bodies 55 located four in each end 21 of the trailer 13.

The adaptor 11 of the embodiment is envisaged for haulage of concentrated sulphuric acid, and so the tank 23 is fabricated from stainless steel sheet. Appropriate adaptors for fluid handling can be used, and while these are not shown in the embodiment, it will be understood that a filling and venting arrangement will be required in one or more positions along the top of the tank 23, and a drainage fitting required along the bottom of the tank. A removable access hatch in the bottom of the load carrying space of the trailer 13, in alignment with the tank drainage fitting needs to be fabricated so that access can be had to the drainage fittings. Depending upon the liquid being carried in the tank, the drainage fitting may comprise an M-TEC™ dry disconnect coupling, as commonly employed in fluid handling. Each of the filling fittings may be located in one or more VOH-200™ hatch 43.

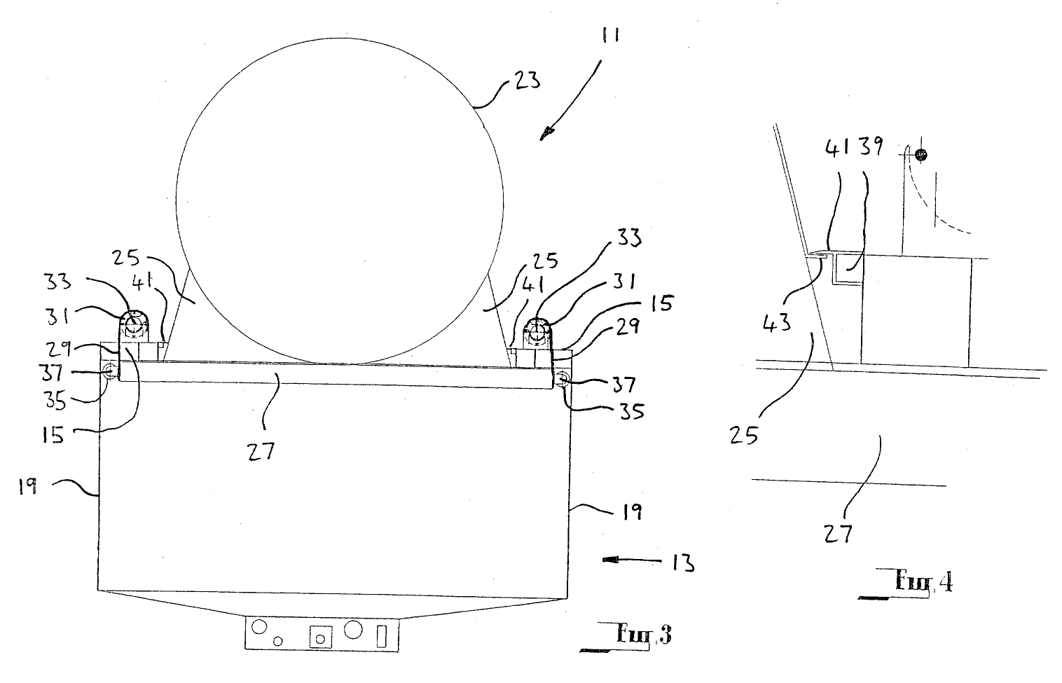

The cycle of operation of use of a trailer 13 fitted with the adapter 11 is that with the adapter 11 in the raised position as shown in FIGS. 2 and 3, the adapter 11 is hinged open as shown in FIG. 5 to allow access to the load carrying space of the trailer 13. The trailer 13 is then filled with bulk ore (for example) and the adapter hinged closed to the position shown in FIGS. 2 and 3. The bulk solids can then be transported to their destination and tipped to a stockpile or the like. The adapter 11 is then lowered to the downward position as shown in FIGS. 1 and 6, where the rigid tank 23 can be filled with liquid. As it is envisaged that the tank 23 can transport concentrated sulphuric acid which has a specific gravity in excess of 1.7, it is important that the tank 23 can be lowered into the load carrying space of the trailer 13. The trailer 13 is driven to the mine where the sulphuric acid (or other liquid is unloaded, and the adapter raised to the upward position ready for transport of bulk solids.

It should be appreciated that the invention is not limited to the actual embodiments described herein. Changes to certain details such as mechanical particulars of construction of the base member 17, and the cover 11, and other details to achieve the same benefits as discussed in the embodiments, may be made, without departing from the spirit and scope of the invention.

The claims defining the invention are as follows

1. In an open topped body used for the stowing, storage, or transport of goods, the body having a base bounded by side(s); a rigid tank supported from an upper region of said body, said rigid tank being supported on a base member, said base member being movable between an upward position in which said rigid tank is raised substantially above said body and said body can be used for stowage of goods, and a downward position in which said rigid tank is located substantially within said body and can be used for holding fluid.

2. In said open topped body, a rigid tank as claimed in claim 1, wherein sealing means are provided to seal said body when said base member is in said upward position to prevent loss of goods during transport.

3. In said open topped body, a rigid tank as claimed in claim 1 or 2 wherein said base member is supported from a frame assembly which attaches to said body, said frame assembly having an aperture located therein through which said rigid tank may pass, said sealing means being provided to seal between said base member and said frame assembly in said upward position to form a cover for said body.

4. In said open topped body, a rigid tank as claimed in claim 2 or 3 wherein said sealing means is attached to said base member.

5. In said open topped body, a rigid tank as claimed in claim 3 or 4 wherein said base member has dimensions which exceed the maximum dimensions of said aperture, said sealing means being provided between the upper surface of said base member and the lower surface of said frame assembly around said aperture.

6. In said open topped body, a rigid tank as claimed in claim 3 or 4 wherein said sealing means is located proximal to said base member, to interfere with said frame assembly as said base member is moved toward said raised position.

7. In said open topped body, a rigid tank as claimed in any one of the preceding claims wherein said frame assembly is pivotally attached to said body to facilitate loading of said body with bulk solids when in said upward position.

8. An adaptor to allow an open topped body used for the stowing, storage, or transport of goods, to hold bulk fluid without cross contamination, the body having a base bounded by side(s), wherein said adaptor comprises a rigid tank supported from an upper region of said body, said rigid tank being supported on a base member, said base member being movable between an upward position in which said rigid tank is raised substantially above or in an upper region of said body and said body can be used for stowage of goods, and a downward position in which said rigid tank is located within said body and can be used for holding fluid.

9. An adaptor as claimed in claim 8 wherein sealing means are provided to seal said body when said base member is in said upward position to prevent loss of goods during transport.

10. An adaptor as claimed in claim 9 wherein said sealing means is attached to said adaptor.

11. An adaptor as claimed in claim 7 or 8 wherein said base member is supported from a frame assembly which attaches to said body, said frame assembly having an aperture located therein through which said rigid tank may pass, said sealing means being provided to seal between said base member and said frame assembly in said upward position to form a cover for said body.

12. An adaptor as claimed in claim 11 wherein said sealing means is attached to said base member.

13. An adaptor as claimed in claim 11 or 12 wherein said base member has dimensions which exceed the maximum dimensions of said aperture, said sealing means being provided between the upper surface of said base member and the lower surface of said frame assembly around said aperture.

14. An adaptor as claimed in claim 11 or 12 wherein said sealing means is located proximal to said base member, to interfere with said frame assembly as said base member is moved toward said raised position.

15. An adaptor as claimed in any one of claims 11 to 14 wherein said frame assembly is pivotally attached to said body to facilitate loading of said body with bulk solids when in said upward position.

16. A freight vehicle comprising an open topped body used for the stowing, storage, or transport of goods, the body having a base bounded by side(s); wherein a rigid tank is provided, supported from an upper region of said body, said rigid tank being supported on a base member, said base member being movable between an upward position in which said rigid tank is raised substantially above said body and said body can be used for stowage of goods, and a downward position in which said rigid tank is located substantially within said body and can be used for holding fluid.

17. A freight vehicle as claimed in claim 16 wherein sealing means are provided to seal said body when said base member is in said upward position to prevent loss of goods during transport.

18. A freight vehicle as claimed in claim 16 or 17 wherein said base member is supported from a frame assembly which attaches to said body, said frame assembly having an aperture located therein through which said rigid tank may pass, said sealing means being provided to seal between said base member and said frame assembly in said upward position to form a cover for said body.

19. A freight vehicle as claimed in claim 17 or 18 wherein said sealing means is attached to said base member.

20. A freight vehicle as claimed in claim 18 or 19 wherein said base member has dimensions which exceed the maximum dimensions of said aperture, said sealing means being provided between the upper surface of said base member and the lower surface of said frame assembly around said aperture.

21. A freight vehicle as claimed in claim 18 or 19 wherein said sealing means is located proximal to said base member to interfere with said frame assembly as said base member is moved toward said raised position.

22. A freight vehicle as claimed in any one of claims 16 to 21 wherein said frame assembly is pivotally attached to said body to facilitate loading of said body with bulk solids when in said upward position.

23. A freight vehicle substantially as herein described with reference to the drawings.

24. An adaptor to allow an open topped body used for the stowing, storage, or transport of goods, to hold bulk fluid without cross contamination, substantially as herein described with reference to the drawings.

25. In an open topped body used for the stowing, storage, or transport of goods, the body having a base bounded by side(s); a rigid tank supported from an upper region of said body, substantially as herein described with reference to the drawings.
